(19) United States
(12) Patent Application Publication
(10) Pub. No.: US 2014/0168513 A1
(43) Pub. Date: Jun. 19, 2014

(54) ELECTRONIC APPARATUS, METHOD OF CONTROLLING AN ELECTRONIC APPARATUS AND PROGRAM FOR CONTROLLING AN ELECTRONIC APPARATUS

(71) Applicant: Kabushiki Kaisha Toshiba, Tokyo (JP)

(72) Inventor: Takayuki Mori, Hachioji-shi (JP)

(73) Assignee: KABUSHIKI KAISHA TOSHIBA, Tokyo (JP)

(21) Appl. No.: 13/898,844

(22) Filed: May 21, 2013

(30) Foreign Application Priority Data
Dec. 13, 2012 (JP) 2012-272524

(51) Int. Cl. H04N 5/44

(52) U.S. Cl. CPC H04N 5/4401
USPC 348/474

(57) ABSTRACT

According to one embodiment, an electronic apparatus has a receiver that receives main video data and difference data including a difference between the main video data and high-quality data. The apparatus further has a generator that uses the main video data and the difference data, thereby to generate high-quality video data higher in quality than the main video data. Further, the apparatus has an output device that outputs acquisition information related to the difference data.

### CROSS-REFERENCE TO RELATED APPLICATIONS

This application is based upon and claims the benefit of priority from Japanese Patent Application No. 2012-272524, filed Dec. 13, 2012, the entire contents of which are incorporated herein by reference.

### FIELD

Embodiments described herein relate generally to an electronic apparatus, a method of controlling an electronic apparatus, and a program for controlling an electronic apparatus.

### BACKGROUND

At present, electronic apparatuses (image displays) are widely used, each able to process video data, called 2k1k, composed of 1920 pixels (horizontal)×1080 pixels (vertical).

In recent years, ultra-high-definition video data has been realized, such as 4k2k video data composed of 3840 pixels (horizontal)×2160 pixels (vertical) and 8k4k video data composed of 7680 pixels (horizontal)×4320 pixels (vertical).

Further, the ultra-high-definition TV (UHDTV) has been developed, which can display ultra-high-definition images represented by ultra-high-definition video data.

In connection the distribution of the above-mentioned ultra-high-definition video data, how to transmit this video data in the limited transmission band is now very important.

If the transmission path has but limited capacity, the following technique may be utilized to transmit, through this path, the high-quality video data, i.e., extremely large data.

First, main video data composed of fewer pixels than the high-quality video data is generated. Then, difference video data is acquired, which is a difference the high-quality video data and the main video data. Next, both the main video data and the difference video data are transmitted. At the receiving side, the difference video data is synthesized with the main video data, thereby reproducing the high-quality video data.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram showing an exemplary configuration of a transmission/reception system to which an embodiment is applied;

FIG. 2 is a diagram showing an exemplary transmitting apparatus that may be used in the embodiment;

FIG. 3 is a diagram showing an exemplary reception apparatus that may be used in the embodiment;

FIG. 4 is a diagram explaining the data structure in the large-capacity storage device shown in FIG. 3;

FIG. 5 is a diagram showing some components, for explaining how the reception apparatus operates in the embodiment;

FIG. 6 is a flowchart showing an exemplary operation the reception apparatus performs in the embodiment;

FIGS. 7A and 7B are diagrams showing an exemplary program table displayed on the screen in the embodiment;

FIG. 8 is a diagram showing an exemplary recorded program table displayed on the screen in the embodiment;

FIG. 9 is a diagram showing an exemplary acquisition state screen displayed, in the form of a picture-in-picture, when a difference data designating button is pushed;

FIG. 10 is a diagram showing examples of remote controllers;

FIG. 11 is a diagram showing an example of a program table which is stored in the system memory or the large-capacity storage device and which is displayed by a display;

FIG. 12 is a diagram showing another example of a program table similar to the table shown in FIG. 11;

FIG. 13 is a diagram showing an example of data the display of the reception apparatus displays while a 4k2k program is being viewed;

FIG. 14 is a diagram showing an exemplary program table data; and

FIG. 15 is a diagram showing still another example of a program table similar to the table shown in FIG. 11.

### DETAILED DESCRIPTION

Various embodiments will be described hereinafter with reference to the accompanying drawings.

Various methods have been proposed as methods of transmitting high-quality video data from a transmission apparatus to a reception apparatus. It is assumed here that the high-definition (HD) level of the high-quality video data (HD video data) is higher than the standard quality (standard-definition (SD)) level equivalent to the definition level of conventional analog TV signals. Note that the video data is also known as image data.

Now assume, the high-quality video data is divided into main video data and difference video data, then the main video data and the difference video data are transmitted individually. In this case, the synchronization between the main video data and the difference video data may be shifted at a receiver. If both the main video data and the difference video data are combined without synchronization at the receiver, it is impossible to obtain a high quality image data.

In general, according to one embodiment, there is provided an electronic apparatus, a method of controlling an electronic apparatus, and a program for controlling an electronic apparatus. An object of the embodiment is to inform the user of the video data acquisition state, particularly the state of acquiring the difference video data.

According to an embodiment, an electronic apparatus has a receiver configured to receive the main video data and the difference data including the difference between the main video data and high-quality video data.

The apparatus further has a generator configured to use the main video data and the difference data, and generate high-quality image data higher in quality than the main video data. The high-quality image data may be called as high-resolution image data.

Still further, the apparatus has an acquisition data output device configured to output information representing the state of acquiring the difference data.

The embodiment will be further described with reference to the drawings.

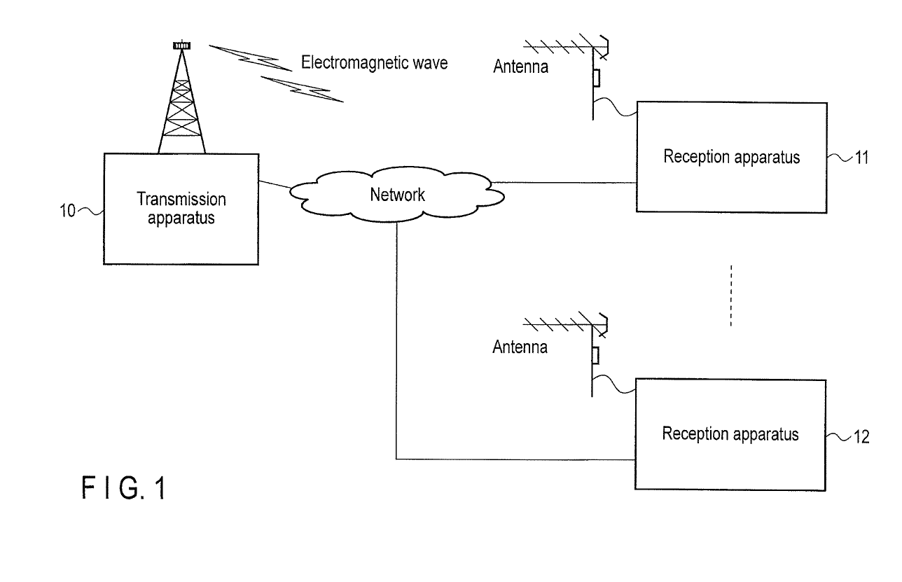

In FIG. 1, reference number 10 designates a transmission apparatus such as a server. The transmission apparatus 10 transmits a broadcast signal via an antenna or a network. The broadcast signal is received by reception apparatuses (for example, television receivers, recording/reproducing apparatuses, personal computers, one-segment receivers, or mobile terminals) 11 and 12.

In this embodiment, electromagnetic waves, for example, are used as medium to transmit main video data, and a network is used to transmit difference video data. The main video data, for example, data composed of 1920 pixels (horizontal)×1080 pixels (vertical), has been generated from high-quality video data, for example, data composed of 3840 pixels (horizontal)×2160 pixels (vertical). The difference data, which has been generated for transmission, represents the difference between the main video data and the high-quality data.

Known as capable of displaying images represented by video data is an apparatus that displays an image represented by the so-called 2k1k video data, i.e., high-definition video data composed of 1920 pixels (horizontal)×1080 pixels (vertical).

Recently, even higher-definition video data has been realized, such as 4k2k video data composed of 3840 pixels (horizontal)×2160 pixels (vertical) and 8k4k video data composed of 7680 pixels (horizontal)×4320 pixels (vertical).

In this embodiment, the high-quality video data, for example, video data generated from the main video data and difference data received at the receiving side, may represent a higher-quality image than the image represented by the main video data. Such video data will hereinafter be called “high-quality video data.”

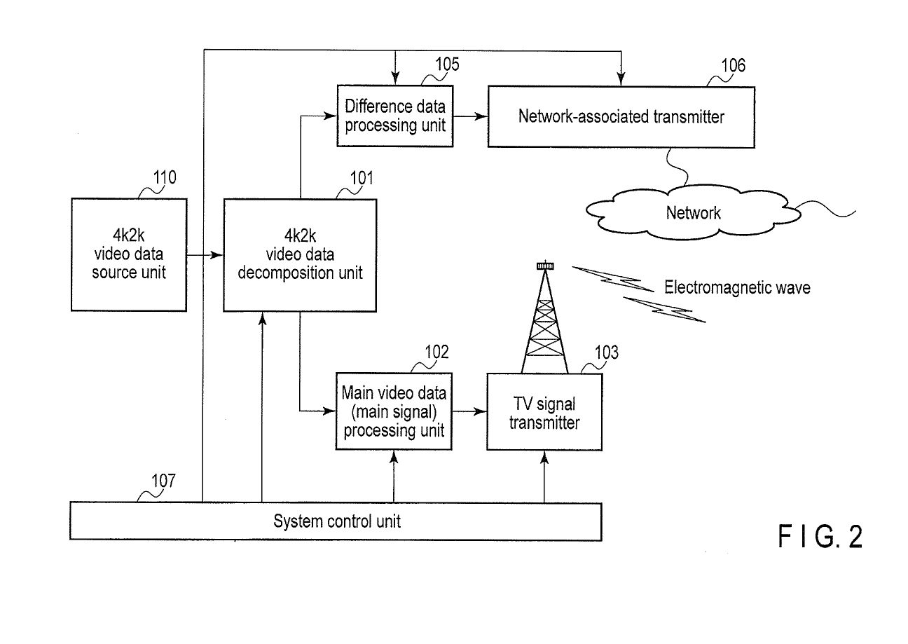

FIG. 2 shows the block configuration of the transmission apparatus 10. In FIG. 2, reference number 110 designates a 4k2k video data source unit.

The 4k2k video data source unit 110 is, for example, a storage medium or a high-resolution camera apparatus.

The 4k2k video data read from the 4k2k video data source unit 110 is input to a 4k2k video data decomposition unit 101.

The 4k2k video data decomposition unit 101 splits the 4k2k video data into main video data and difference data.

The main video data is encoded into a signal to transmit, in a main video data processing unit 102. The main video data, so encoded, is converted to a transmission signal in a TV signal transmitter 103. The transmission signal is transmitted, in the form of an electromagnetic wave, from an antenna.

Meanwhile, the difference data is encoded into a signal in a difference data processing unit 105. The signal is transmitted via a network and is supplied to a network-associated transmitter 106. The network-associated transmitter 106 changes the signal to a signal of a network-transmission format. The signal, so changed in format, is transmitted to the network.

A system control unit 107 controls the other blocks provided in the transmission apparatus 10.

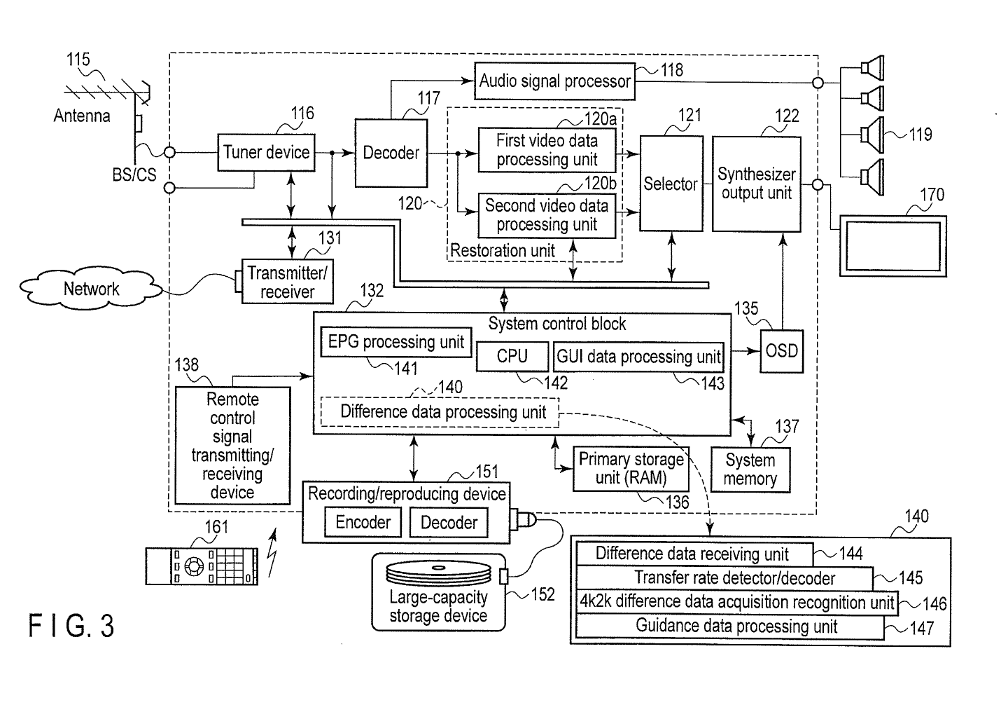

FIG. 3 shows the blocks constituting an electronic apparatus, more precisely the reception apparatus 11.

The electronic apparatus has a data receiving unit, a data generating unit, and an acquired data output unit. The data receiving unit receives the main video data and difference data, i.e., difference between the main video data and the high-quality data. The data generating unit uses the main video data received and the difference data received, generating high-quality video data representing an image higher in quality than the image represented by the main video data. The acquisition data output unit outputs data representing the difference data acquisition state.

The electromagnetic wave received by an antenna 115 is guided to a tuner device 116. The tuner device 116 includes, for example, a plurality of tuners, and can therefore receive, at the same time, signals of several channels (for example, seven channels).

The tuner device 116 may further include tuners configured to receive digital broadcast signals coming from broadcasting satellites (BS) or communication satellites (CS). The program signals (transport stream state), the tuners receive at the same time, can be recorded in a large-capacity storage device 152, by the encoder provided in a recording/reproducing device 151 under the control of a system control block 132.

This recording method may be called time-shift recording in some cases. Any signal reproduced from the large-capacity storage device 152 under the control of the system control block 132 is decoded by the decoder provided in the recording/reproducing device 151. The decoded output (i.e., stream) is guided to a video signal processor (also called a restoration unit) 120.

Signals can be recorded in, and reproduced from, the large-capacity storage device 152 in accordance with, for example, the operation at a remote controller 161. Any control signal generated in the remote controller 161 is input to the system control block 132 through a remote control signal transmitting/receiving device 138.

The stream of the channel selected by the tuner device 116 undergoes packet isolation and decoding in a decoder 117. The transport stream includes packets of various types (i.e., control signal packets, audio packets, video packets, etc.). The video data contained in the transport stream is encoded by, for example, the moving picture expert group (MPEG) system, the advanced video coding (AVC) system, or the like.

The audio data contained in any audio packet is encoded by the pulse code modulation (PCM) system, the MPEG system, or the like. Hence, the audio data and video data are decoded by the decoding system associated with the encoding system used.

Any control signal packet is guided to the system control block 132. The control signal packet may contain, in some cases, the systems of compressing and encrypting video data and the attributes of video data.

The control signal packet further contains electronic program guide (EPG) data. The EPG data is processed in an EPG processing unit 141 to generate program table data.

The EPG data accumulated includes the programs broadcast in the past, the programs being broadcast at present, and the programs to be broadcast in the future. From the EPG data, program tables for the past, present and future can therefore be generated. The data representing any program table generated is stored in a system memory 137.

A part of the program table data to display, which should be updated, is updated every three days, every four days, or every week. The program table data includes the programs broadcast in, for example, three months in the past, and the programs to be broadcast in, for example, one month in the future.

The audio data is input to an audio signal processor 118, which performs synchronization and volume adjustment on the audio data. The audio signal processor 118 further performs stereophonic signal splitting that accords with a speaker system 119. The output of the audio signal processor 118 is supplied to the speaker system 119.

The video data decoded undergoes synchronization, luminance adjustment and color adjustment in the video signal processor 120.

The output of the video signal processor 120 is output to a display 170 via a selector 121 and a synthesizer output unit 122. The video signal processor 120 includes a first video data processing unit 120a and a second video data processing unit 120b.

The first video data processing unit 120a processes, for example, SD video data. The second video data processing unit 120b reconstructs the high-quality video data. The second video data processing unit 120b synthesizes, for example, the main video data generated from the high-quality video data, with the difference data that is the difference between the main video data and the high-quality video data and that has been generated to be transmitted. The second video data processing unit 120b can therefore reproduce the original high-quality video data.

It should be noted here that good high-quality video data cannot always reproduced. Thus, the second video data processing unit 120b functions as a data generating unit, cooperating with the control block, thereby to use the main video data received and also the difference data received and to generate video data of higher quality than the main video data.

The selector 121 selects the output of the first video data processing unit 120a or the output of the second video data processing unit 120b, and supplies the output to the synthesizer output unit 122. The synthesizer output unit 122 can multiplex the video data with data, figure data, program table data and acquisition state data representing a acquisition state display screen (later described), all supplied from the system control block 132.

The reception apparatus 11 further comprises an output unit (not shown in FIG. 3). The output unit sets a scale, resolution, number of lines and aspect ratio, etc., which accord with the display 170, and outputs these items to the display 170.

The reception apparatus 11 further has a transmitter/receiver 131, which is connected to the network.

The reception apparatus 11 can therefore receive the difference data from the transmission apparatus 10, as shown in FIG. 1.

Various methods of receiving the difference data are available. The difference data is processed by a difference data processing unit 140 provided in the system control block 132. In FIG. 3, the difference data processing unit 140 is displayed, as if removed from the system control block 132.

The difference data processing unit 140 includes a difference data receiving unit 144, a transfer rate detector/decoder 145, a 4k2k difference data acquisition recognition unit 146, and a guidance data processing unit 147. The guidance data processing unit 147 cooperates with a GUI data processing unit 143, functioning as acquisition data output unit.

Assume that the source video data of program AAA is 4k2k video data. Then, the guidance data of the program AAA contains data showing that program AAA is 4k2k video data. Alternatively, the control signal packet transmitted together with the packet containing the video data of program AAA contains the data showing that program AAA is 4k2k video data.

Therefore, the difference data receiving unit 144 of the difference data processing unit 140 can determined that which program can provide 4k2k video data.

(1) In a method, the reception apparatus 11 has entered contract with the transmission apparatus (i.e., server) 10, in order to acquire the difference data; alternatively, the reception apparatus 11 has transmitted a request signal to the transmission apparatus 10, requesting for the difference data.

The transmission apparatus 10 can therefore transmit the difference data to the reception apparatus 11 before the broadcasting of, for example, program AAA, is started.

(2) In another method, the reception apparatus 11 can request for the difference data of, for example, program AAA, in order to acquire the difference data.

The reception apparatus 11 may request the transmission apparatus 10 for the difference data. In this case, a request signal is transmitted from the reception apparatus 11 to the transmission apparatus, in accordance with the user's operation.

Alternatively, the request signal is automatically transmitted from the reception apparatus 11 to the transmission apparatus 10, in accordance with instructions that have been preset.

The difference data the difference data receiving unit 144 has received is processed by the transfer rate detector/decoder 145, which detect the transfer rate. The difference data is decoded, with its format changed from the network transfer format to the original format.

If the length and transfer rate of a program and the average number of bits per frame of difference data are known, the percentage of the difference data acquired, for the program, cab be calculated. The difference data acquisition state detected at all times by the 4k2k difference data acquisition recognition unit 146.

The data representing the difference data acquisition state is determined for each program. The guidance data processing unit 147 generates data representing the ratio of the difference data acquired thus far. This data is stored in, for example, a system memory 137.

In the header of the difference data, a timestamp (time data for achieving synchronization) is described. The timestamp is identical to the timestamp of the packet of the main video associated with the difference data.

Hence, if the timestamp of the difference data is obtained, it is possible to calculate the ratio (i.e., acquisition state) of the difference data acquired, to the main video data.

The guidance data processing unit 147 can output various guidance data (for example, messages to the user) about the difference data, in response to an operation performed at the remote controller 161.

The guidance data processing unit 147 can also generate acquisition state video data that contains the various guidance data. The acquisition state represented by the acquisition state video data is displayed by the display 170, as an acquisition state image (later described).

The acquisition state is, for example, the time required for acquiring the remaining difference data. The various guidance data are input to the GUI data processing unit 143, either directly or via the system memory 137. The guidance data is output, as video data, from the GUI data processing unit 143. The guidance data can be processed, generating bar-graph data, pie-chart data, etc. Thus, the control unit (for example, guidance data processing unit 147) generates the data representing the difference data acquisition state, as described above.

The GUI data processing unit 143 cooperates with an on-screen display (OSD) unit 135 to use the program table data stored in the system memory 137, thereby causing the display 170 to display a program table. The GUI data processing unit 143 may further cooperates with an on-screen display (OSD) unit 135 to use the data representing the data stored in the system memory 137 and representing the difference data acquisition state, thereby to cause the display 170 to display the state of difference data about a 4k2k program. (This state can also be called the state of preparing the difference data.) A CPU 142 adjusts the entire operating sequence of the system control block 132, controlling the other components of the system control block 132.

In the electronic apparatus, the difference data may be acquired while a 4k2k program is being viewed. Alternatively, the difference data may be acquired before the broadcasting of the 4k2k program is started. Still alternatively, the difference data may be acquired before the 4k2k program and the difference data are viewed.

In whichever case, the difference data is temporarily stored in the large-capacity storage device 152 or the system memory 137 (or primary storage unit 136). The difference data pertain to a plurality of programs. Therefore, once the difference data has been stored in a storage medium, both its recorded state and the method of managing it must be defined.

The system control block 132, video signal processor 120 and recording/reproducing device 151, all described above, can be implemented in the form of hardware. Alternatively, they can, of course, be implemented in the form of a data processing function composed of a computer and software. In this case, the software can be stored in a storage medium such as a semiconductor memory, a magnetic disk or an optical disk.

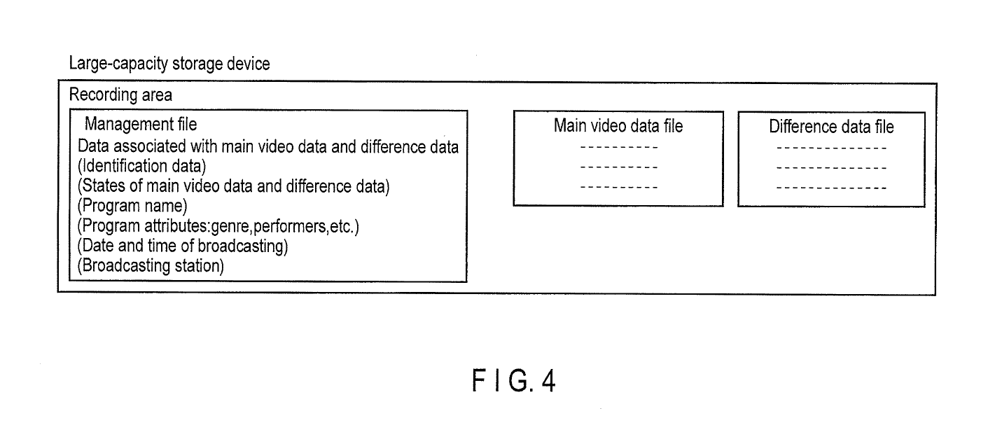

FIG. 4 shows an exemplary method of recording and managing the difference data. The large-capacity storage device 152 uses, for example, a hard disk as storage medium. In this case, the recording area of the hard disk has a management file region, a main video data file region, and a difference data file region. The data associated with the main video data and difference data is stored in the management file.

The data so associated includes the identification data of the main video data, the difference data associated therewith, the data representing the status of the main video data and the status of the difference data (i.e., not recorded, recorded or being recorded, being prepared, missing, etc.), the program attribute data (for example, title, genre, performers), the broadcasting date/time, the broadcasting station, and the like.

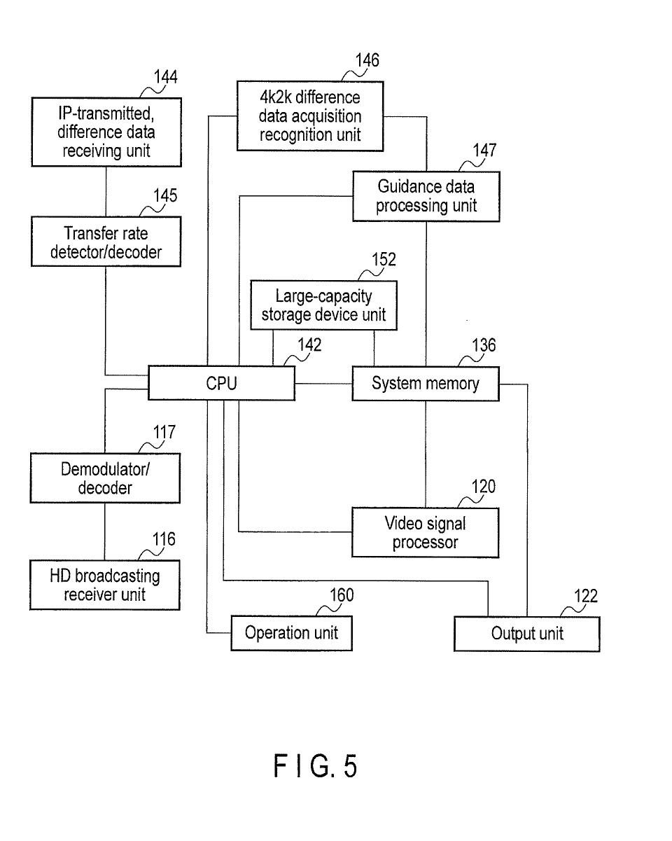

FIG. 5 shows blocks related to particularly 4k2k difference data. These blocks, which are identical to some of the blocks shown in FIG. 5, are designated by the same reference numbers as used in FIG. 3.

Under the control of the CPU 142, the difference data receiving unit 144 receives the difference data. The difference data is decoded by the transfer rate detector/decoder 145. Meanwhile, the tuner device 116 receives the main video data, which is decoded by the demodulator/decoder 117.

The difference data decoded is stored in the large-capacity storage device 152 under the control of the CPU 142. The 4k2k difference data acquisition recognition unit 146 determines the acquisition ratio of difference data, for the program to view, under the control of the CPU 142. The device 152 then stores the acquisition ratio data as display data in the system memory 136 or large-capacity storage device 152, for example through the GUI data processing unit 143.

Meanwhile, the signal received by the tuner device 116 is demodulated and decoded in the demodulator/decoder 117, and stored as main video data in, for example, the large-capacity storage device 152 under the control of the CPU 142. Alternatively, this signal is supplied to the output unit 122 through the video signal processor 120. In either case, the output unit 122 synthesizes the difference signal in the large-capacity storage device 152 with the main video data, generating 4k2k video data, which can be output.

Moreover, the GUI data stored in the system memory 137 can be read as the user operates an operation unit 160, and can then be supplied to the output unit 122. The GUI data contains the program table data and the data representing the difference data acquisition state, as will be describe later in detail.

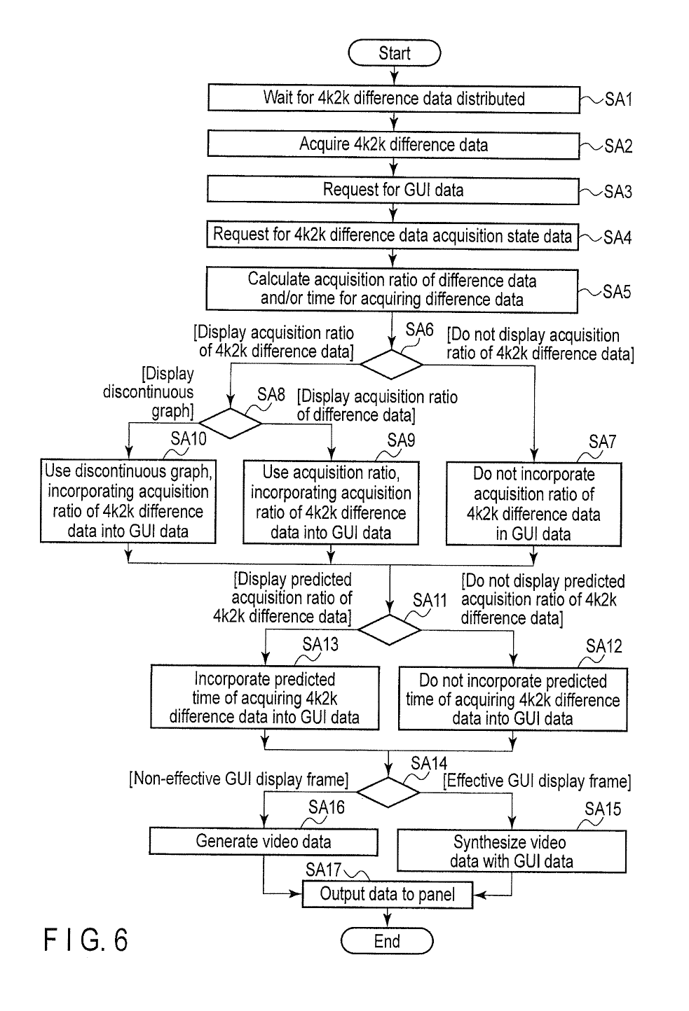

FIG. 6 is a flowchart explaining an exemplary operation this embodiment performs. The following explanation is based on the assumption that the function of receiving 4k2k difference data has already been activated.

The difference data, which has been waited for, is received (Step SA1). Then, a process of acquiring the difference data is performed (Step SA2). Upon acquiring the difference data, a GUI processing request command is issued to convert the difference data to GUI data (Step SA3).

Next, a command is issued, requesting for the generation of difference data acquisition state data (Step SA4). In response to this command, the acquisition ratio of difference data and/or the time for acquiring the difference data is calculated (Step SA5).

Then, in response to a command already made or preset, it is determined whether the acquisition ratio of difference data should be displayed or not (Step SA6). If a non-display command or any setting has been made, the difference data is not displayed at all (Step SA7).

If a display command or any setting has been made, the next decision will be made. That is, it is determined which graph should be displayed, a graph showing the ratio of acquired difference data to the total program data or a graph missing the difference data acquisition state (i.e., a discontinuous graph). This decision can be made in accordance with an operation input or a preset input.

Which type of a graph should be displayed can be determined in accordance with an operation input or a preset input (Step SA8).

If it is determined that the graph showing the ratio of acquired difference data to the total program data should be displayed, the data representing difference data acquisition state is output in Step SA9. The graph shows the difference data acquisition ratio in percentage, on the basis of the total program data (100%).

If it is determined that the graph is missing the difference data acquisition state (i.e., a discontinuous graph), the data representing difference data acquisition state is output in Step SA10. This graph shows the difference data acquisition ratio in percentage, also on the basis of the total program data (100%).

If the entire difference data associated with the program has not been acquired yet, it is determined whether the time predicted to pass until entire difference data is acquired should be displayed or not (Step SA11).

If the user selects “Do not display time” or does nothing for a prescribed time, the operation goes to Step SA12. In Step SA12, the time predicted to pass until entire difference data is acquired is not displayed. Conversely, if the user selects “Display time,” the operation goes to Step S13. In Step S13, the time predicted to pass until entire difference data is acquired is processed into acquisition state video data, which is output.

The time can be predicted as follows. As described above, the ratio of the difference data already acquired to the associated program data (i.e., present percentage) has been calculated. The ratio of that part of difference data, which has not been acquired yet, to the associated program data can therefore be calculated at once.

Further, the time spent to acquire difference data of the present percentage is known. Still further, the time for acquiring unit amount, for example 10%, of difference data is known. Hence, the time for acquiring all difference data can be calculated, by using the percentage of difference data needed and the time for acquiring unit amount of difference data.

The acquisition state video data generated through the above-described calculation is synthesized with the frame of main video data in Steps SA14 and SA15. In Step SA17, the display 170 displays the acquisition state represented by the acquisition state video data. There is timing at which the acquisition state video data is not synthesized with the frame of main video data (Steps SA14 and SA16).

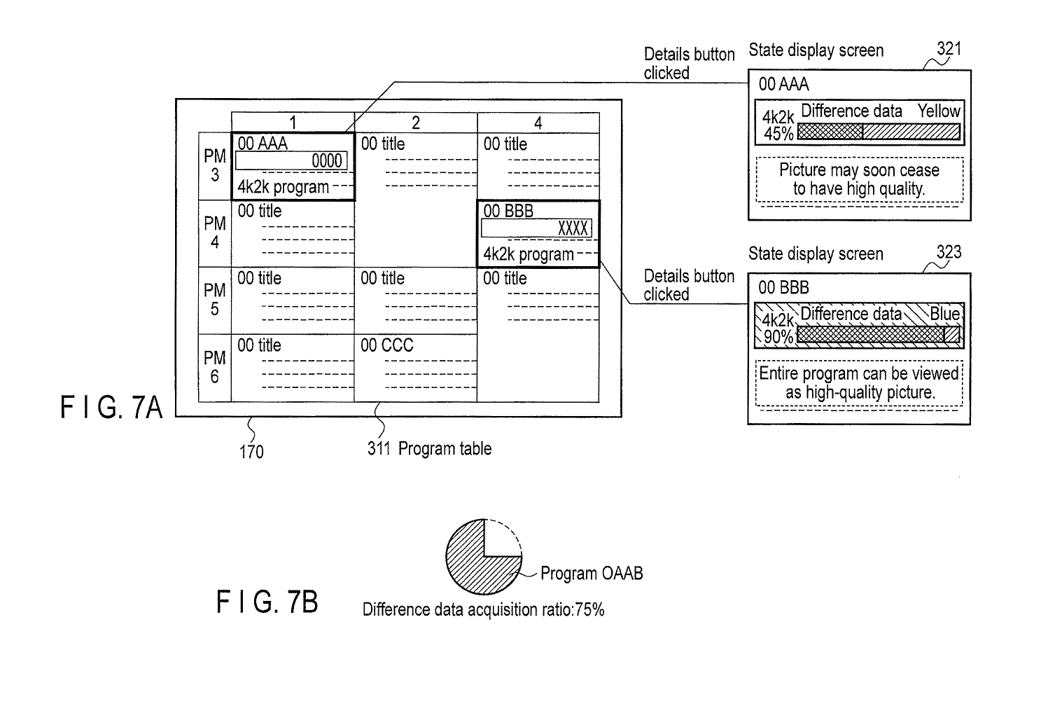

FIG. 7 shows the screen of the display 170, displaying an exemplary program table 311.

Assume that the user operates the remote controller, moving the cursor to a program AAA position on the screen. In the program guidance area of the screen, characters, symbol or mark is displayed, indicating that the program AAA is a 4k2k program.

The user can therefore know that program AAA is a 4k2k program. If the user clicks the Details button on the remote controller, an acquisition state display screen 321 is displayed on the display 170. The acquisition state display screen 321 is optional in terms of size and display position.

In the acquisition state display screen 321, the difference data acquisition state (acquisition ratio) is displayed in the form of, for example, both a numerical value and a bar graph.

In the screen 321 shown in FIG. 7, the difference data acquisition state is 45%.

If the user keeps viewing program AAA, the difference data will become inadequate. Consequently, the image being viewed may no longer be a high-quality image. In this case, a message of, for example, “Picture may soon cease to have high quality.”

The background of the bar graph may be colored, for example, yellow, to give an alarm to the user.

As described above, an acquisition state display screen is displayed if the user clicks the Details button. Instead, the acquisition state display screen may be automatically popped up when the cursor is moved to the program guidance area of the screen. Thus, the user can know that the program at the cursor position is a 4k2k program, even if he or she has moved the cursor in order to know the ratio of difference data already acquired.

Another case will be described. Assume that the user operates the remote controller, moving the cursor to the program “BBB” position on the screen.

In this case, too, characters, symbol or mark is displayed in the program guidance area of the screen, indicating that the program is a 4k2k program. If the user clicks the Details button on the remote controller, an acquisition state display screen 323 is displayed.

The acquisition state display screen 323 displays that 90% of difference data has been acquired. In this case, it is determined from the predicted difference data acquisition that program BBB can be continuously viewed as 4k2k program. Then, a message is displayed, which reads, “Entire program can be viewed as high-quality picture.”

After the above-mentioned decision has been made, the background of the bar graph may be colored, for example, blue, to inform the user that the reception apparatus 11 is operating in safety.

Of each of the bar graphs displayed on the acquisition state display screens 321 and 323, the left and right halves indicate, in percentage, two parts of the difference data part, respectively, one part already acquired and the other part not acquired yet. Nonetheless, the manner of displaying the bar graphs is not limited to this.

The bar graphs may be replaced by, for example, pie charts of such a type as shown in FIG. 7B.

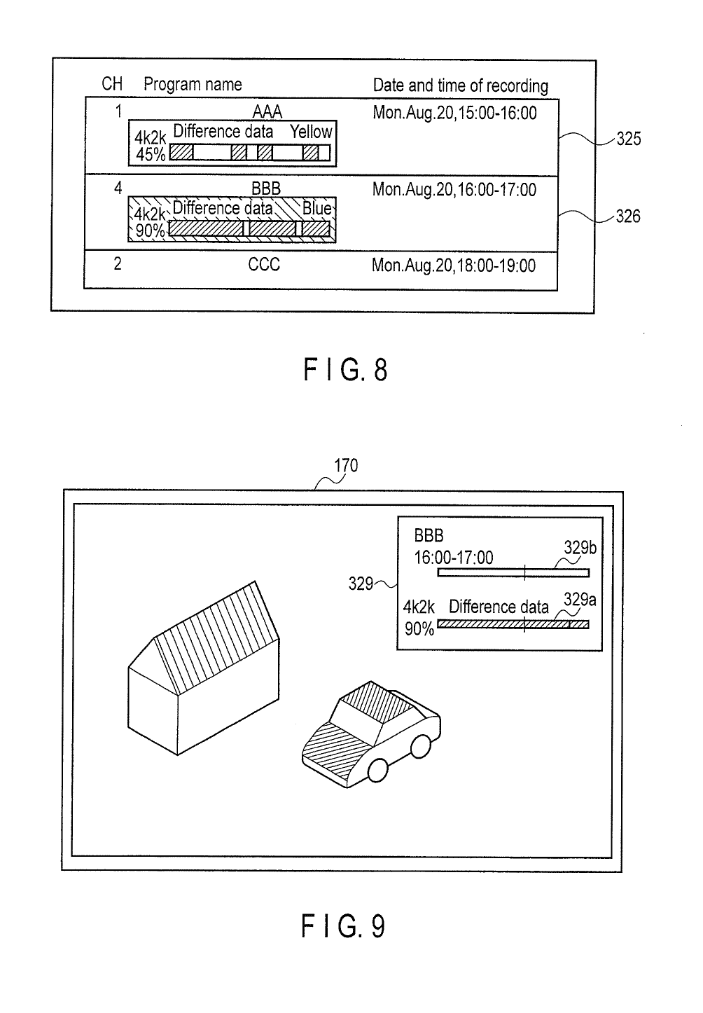

FIG. 8 is a diagram showing an exemplary screen displaying a recorded program table, more precisely showing acquisition state display screens 325 and 326 of another type.

In both display screens 325 and 326, the entire bar indicates the program length and is colored. Of the bar, the parts indicating difference data are spaced apart and displayed a color different from the color of the program.

The user can therefore determine to which period (or position) of the program, each difference data corresponds.

The ratio of difference data acquired is presented in percentage, namely in numerical value.

This is because in some cases, the difference data may not be transmitted while the program is being displayed. In such a case, too, a message may be displayed to inform this fact, as explained above with reference to FIG. 7A.

The state shown in FIG. 8, which program CCC assumes indicates that the difference data has not been acquired. The user can therefore confirm the difference data acquisition state, even if the program table is displayed in this way.

FIG. 8 shows a 4k2k program guidance in connection with three programs. In practice, the 4k2k program guidance pertains to far more programs.

FIG. 9 shows an exemplary acquisition state screen 329, which is displayed, in a picture-in-picture form, when the user presses a difference data designating button (or specific button or resolution button) while he or she is viewing a program.

Also in this case, a bar graph 329a can show the difference data acquisition state in the same manner as shown in FIG. 7A or FIG. 8. In this case, the broadcast time of the program and that part of the program, which is being displayed, are indicated on a bar graph 329b.

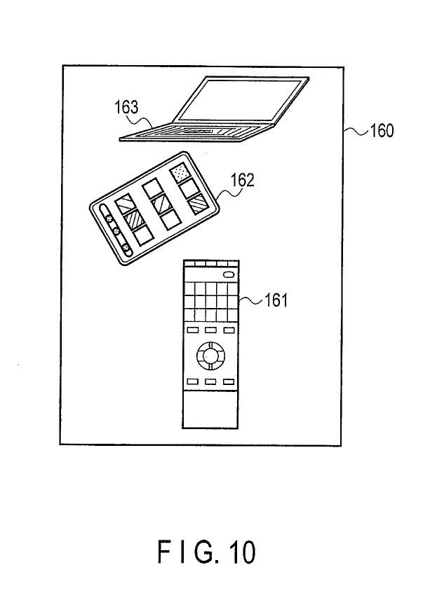

FIG. 10 is a diagram showing examples of remote controllers. As seen from FIG. 10, the remote controller 161 falls in a category of a remote control device 160. The remote control device 160 may be a personal computer 163, a mobile terminal 162 having telephone function, or a tablet.

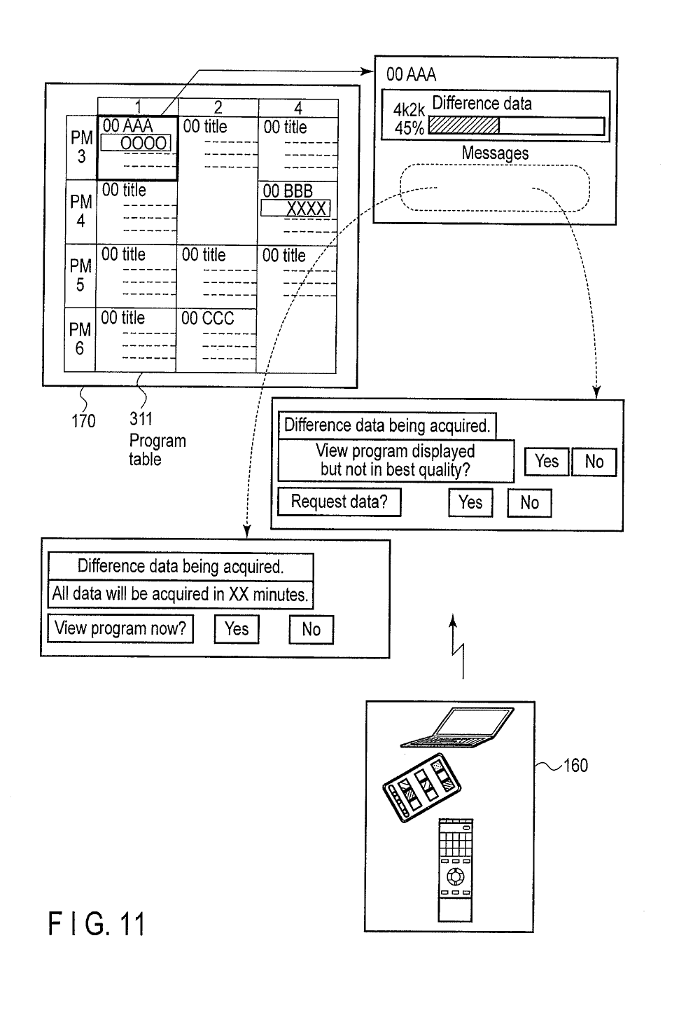

FIG. 11 shows an example of the program table 311 which is stored in the system memory 137 or the large-capacity storage device 152 and which is displayed by the display 170.

The program table 311 shown in FIG. 11 is an acquisition state image, which is popped up when the cursor is moved to any program guidance area. The acquisition state image shows the amount of the difference data of a 4k2k program, which has been acquired. The amount of difference data acquired is presented in a numerical value and also in the form of a bar graph. Nonetheless, the manner of displaying the amount of difference data acquired is not limited to this.

Further, messages may be displayed in the program table 311. The messages read, for example, “Difference data being acquired,” “View program displayed but not in best quality?” and “Request data?”

The message “View program displayed but not in best quality?” is used if the user has recorded the program and therefore needs to acquire the difference data only.

In response to the question “View program displayed but not in best quality?” the user clicks the Yes button or the No button. If the user clicks the Yes button to answer the question, and then clicks OK button, playback of the program will start. In this case, the difference data received is synthesized with the main video data received, restoring the high-quality video data.

In response to the question “Request data?” the user clicks the Yes button or the No button. If the user clicks the Yes button to answer the question, the reception apparatus 11 transmits a request signal via the transmitter/receiver 131 to the prescribed server (i.e., transmission apparatus), requesting for the difference data.

In response to the request signal, the transmission apparatus transmits the difference data. Used as the request signal is, for example, the address contained in the program attribute data. The request signal contains, for example, the name data about the program desired.

When the reception apparatus 11 transmits the request signal, the messages are switched to messages, which read, “Difference data being acquired,” “All data will be acquired in XX minutes,” and “View program now?”

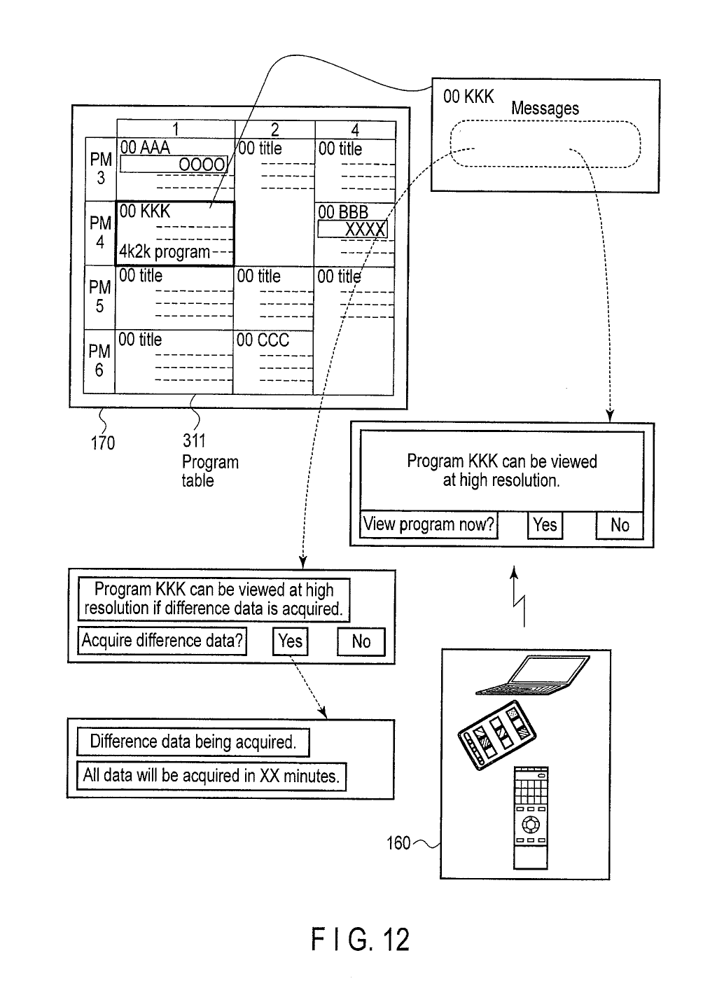

FIG. 12 is a diagram showing another example of the program table 311, different from the example shown in FIG. 11. In a first case, the program broadcast in the past and automatically recorded is a 4k2k program, and the difference data has been acquired.

In a second case, the program broadcast in the past and automatically recorded is a 4k2k program, but the difference data has not been acquired yet. In the second case, the user may not have entered a contract for acquiring the difference data.

If the difference data has already been acquired, messages reading, for example, “Program KKK can be viewed at high resolution” and “View program now?” will be popped up on the display when the user moves the cursor to the program guidance area.

In response to these question messages, the user may click the Yes button or the No button. Alternatively, one of the keys provided on the remote controller may be used as a key that performs the same function as the Yes button.

If the difference data has not been acquired yet, messages reading, for example, “Program KKK can be viewed at high resolution if difference data is acquired” and “Acquire difference data?” will be popped up on the display when the user moves the cursor to the program guidance area.

In response to these question messages, the user may click the Yes button or the No button. If the user clicks the Yes button to answer the question, the messages will be switched to messages that read, “Difference data being acquired,” “All data will be acquired in XX minutes,” and “View program now?”

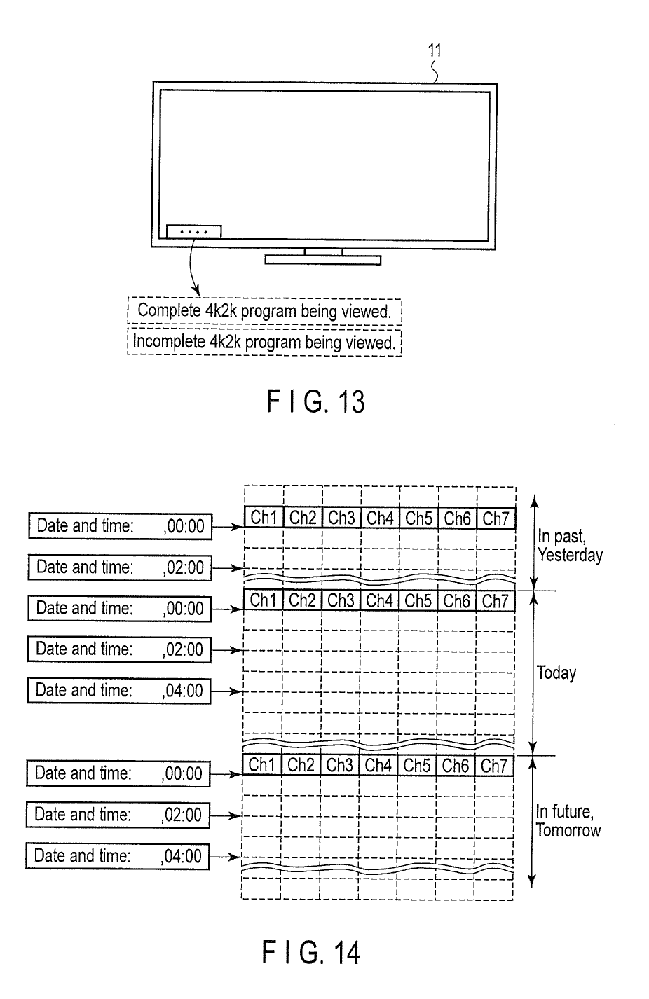

FIG. 13 is a diagram showing an example of data the display of the reception apparatus 11 displays while a 4k2k program is being viewed.

While the user is viewing a 4k2k program, the display keeps displaying a message of “Complete 4k2k program being viewed” or “Incomplete 4k2k program being viewed.” The message “Complete 4k2k program being viewed” is displayed if all diffusion data has been acquired for the program. The message “Incomplete 4k2k program being viewed” is displayed if only a part of the diffusion data has been acquired for the program.

FIG. 14 is a diagram showing an exemplary program table data.

In the reception apparatus 11, the EPG data can be used to generate a program table showing programs broadcast in the past, programs being broadcast at present and programs to be broadcast in the future. Further, the program table can be updated with the passage of time.

FIG. 14 shows an exemplary program table data, for explaining the program table data more clearly. This program table data covers the programs on channels 1 to 7 for today, the programs on channels 1 to 7 for yesterday, and the programs on channels 1 to 7 for tomorrow.

With this embodiment, once the program table has been displayed on the basis of the program table data, the user can reserve the acquisition of any program data to be broadcast in the future.

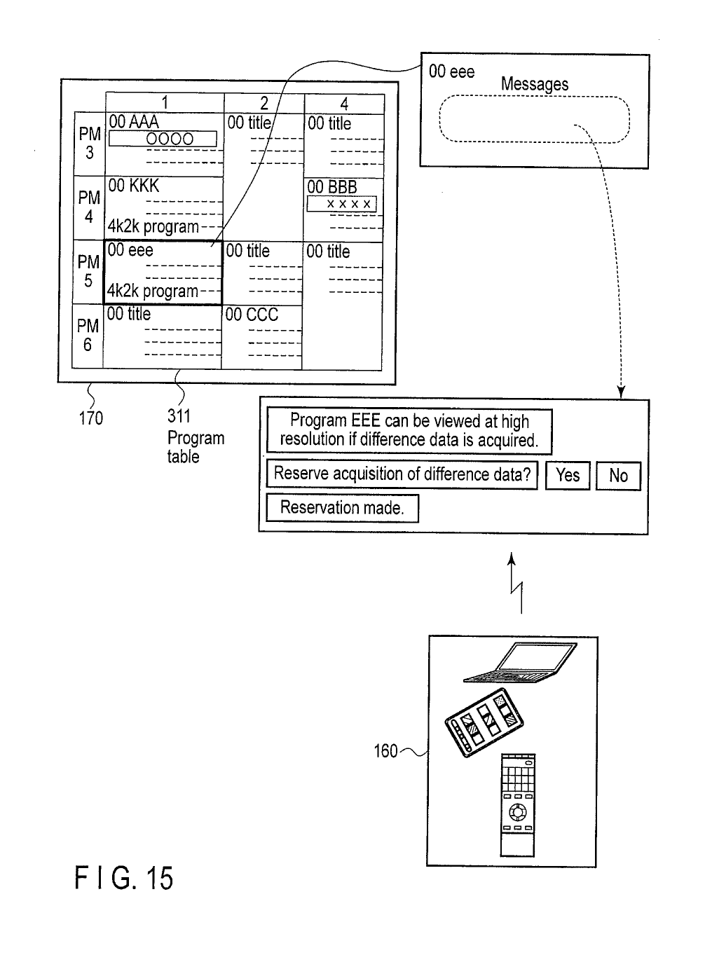

FIG. 15 is a diagram showing still another example of a program table, different from the example shown in FIG. 11.

Once a program table showing the programs to be broadcast in the future has been displayed on the display, on the basis of the program table data, the user can reserve the acquisition of the difference data of program EEE in the program table shown in FIG. 15.

When the user moves the cursor to the program guidance area for program EEE, the display displays messages reading, for example, “Program EEE can be viewed at high resolution if difference data is acquired” and “Reserve acquisition of difference data?” The user can click the Yes button or the No button.

If the Yes button is clicked, a message “Reservation made” will be displayed.

Once the acquisition of difference data has been so reserved, the difference data of the program selected can be downloaded and stored before the program is broadcast. The difference data processing unit 140 of the system control block 132 determines, from the program table data, the time of staring the broadcasting of the program.

The difference data processing unit 140 can therefore download and store the difference data of the program well before the broadcasting of the program is started.

The difference data of even a program broadcast in the past may be transmitted in response to a request in some cases.

In such a case, a message of, for example, “You can request difference data” may be popped up in the program table. In accordance with the message displayed, the user can request the server to transmit the difference data.

In the embodiment described above, the 4k2k, high-resolution video data is transmitted, in the form of two data items, namely the main video data and the difference data, through different paths (namely, a radio path and a network).

Nonetheless, the invention is not limited to this embodiment. Rather, this invention can be applied to a system in which both the main video data and the difference data are transmitted and received in the form of electromagnetic waves, through different channels.

Moreover, the invention is not limited to a system for transmitting and receiving 4k2k, high-resolution video data. The invention can be applied to any signal processing system in which the transmitting side transmits main video data and difference data and the receiving side synthesizes the difference data with the main video data. The concept of this invention can be applied to direct broadcasting by satellite and one-segment terrestrial broadcasting.

The reception apparatus has been described as a television receiver. Nonetheless, the invention can, of course, be applied to any apparatus such as a tablet or a personal computer, which has a receiving unit and can be connected to a display. Further, the invention can be implemented if the program codes are stored in a computer-readable recording medium and if a computer is used to operate the system.

The term “processing unit” used in the above description can, of course, be replaced by “apparatus,” “device,” “block,” “module,” or “controller,” well within the spirit or scope of the present invention. In the claims, each component may be described as some individual elements or some components may be described as one unit, or these ways of describing the components may be used. Even in this case, the claims fall within the spirit or scope of this invention. Further, any claim described as a method should be considered as using the apparatus according to this invention.

The technical terms used above in relation to the embodiments and the names or technical terms described in the drawings are in no way restrictive. For example, the processor may be replaced with processing means, a processing unit, or a processing module. Likewise, the controller may be replaced with control means, a control unit, or a control module. The managing unit may be replaced with a manager, managing means, or a managing module. The generator may be replaced with generating means, a generating unit, or a generating module. The storage unit may be replaced with storage means, a storage or a storage module. The collection and correction unit may be replaced with collection and correction means, or a collection and correction device. The registration unit may be replaced with registration means, a registration device, or a registration module.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a receiver configured to receive main video data and difference data including a difference between the main video data and high-quality data;
a generator configured to use the main video data and the difference data, and generate high-quality video data higher in quality than the main video data; and
an output device configured to output acquisition information related to the difference data.

2. The electronic apparatus of claim 1, further comprising a processor configured to generate the acquisition data.

3. The electronic apparatus of claim 1, wherein the acquisition information represents an acquisition ratio of the difference data.

4. The electronic apparatus of claim 1, wherein the acquisition information represents an acquisition ratio of the difference data in the form of a graph.

5. The electronic apparatus of claim 1, wherein the acquisition information shows whether the high-quality video data can be output, in accordance with an difference data acquisition state.

6. The electronic apparatus of claim 1, wherein the acquisition information shows whether the high-quality video data can be restored in part or in entirety, in accordance with an difference data acquisition state.

7. The electronic apparatus of claim 5, wherein the acquisition state is indicated by color data.

8. The electronic apparatus of claim 6, wherein the acquisition state is indicated by color data.

9. The electronic apparatus of claim 3, wherein the acquisition ratio represented by the acquisition data is displayed in a split form.

10. The electronic apparatus of claim 1, further comprising a program table output device configured to output data for displaying, at a program name shown in a program table, a message informing that the program can be output in the form of the high-quality video data.

11. A method of controlling an electronic apparatus, comprising:
receiving main video data and difference data including a difference between the main video data and high-quality data;
using the main video data and the difference data, and generating high-quality video data higher in quality than the main video data; and
outputting acquisition information related to the difference data.

12. A non-transitory storage medium including a program that, when executed by a data processing unit, controls operations an electronic apparatus, comprising:
receiving, by the data processing unit, main video data and difference data including a difference between the main video data and high-quality data;
using, by the data processing unit, the main video data and the difference data, thereby generating high-quality video data higher in quality than the main video data; and
outputting acquisition information related to the difference data.
